(19) United States
(12) Patent Application Publication
(10) Pub. No.: US 2022/0161643 A1
(43) Pub. Date: May 26, 2022

(54) Sealing Element Having A Cover Section, Vehicle Door And Vehicle Having A Sealing Element, Method For Manufacturing A Sealing Element

(71) Applicant: Audi AG, Ingolstadt (DE)

(72) Inventor: Daniel LEHMANN, Heibronn (DE)

(73) Assignee: Audi AG, Ingolstadt (DE)

(21) Appl. No.: 17/440,634

(22) PCT Filed: Mar. 13, 2020
(86) PCT No.: PCT/EP2020/056966

§ 371 Date: Sep. 17, 2021

(30) Foreign Application Priority Data
Apr. 5, 2019 (DE) 10 2019 204 886.2

(51) Int. Cl. B60J 10/25; B60J 10/76; B60J 10/88; B60J 10/32; B60J 10/277; B29C 48/00; B29C 48/09; B29C 48/12

(52) U.S. Cl. CPC B60J 10/25; B60J 10/76; B60J 10/88; B60J 10/32; B29L 2031/26; B29C 48/0022; B29C 48/09; B29C 48/12; B60J 10/277

(57) ABSTRACT

The present disclosure relates to a sealing element for a front vehicle door having at least one fastening section by means of which the sealing element can be fastened to a frame element of the vehicle door. The sealing element includes at least one channel section forming a drainage channel between a frame element of the vehicle door and a side wall support of the vehicle frame. The sealing element includes a cover section that partially covers a clearance disposed along an exterior side of the channel section. The sealing element covers at least half the width of the clearance of the channel section.

### TECHNICAL FIELD

The present disclosure relates to a sealing element for a front vehicle door having at least one fastening section by means of which the sealing element can be fastened to a frame element of the vehicle door, and at least one channel section which, in the mounted state on the vehicle door, is designed to form a drainage channel between the frame element of the vehicle door and a side wall support of the vehicle frame. The present disclosure also relates to a vehicle door and a motor vehicle having such a sealing element and a method for producing such a sealing element.

### BACKGROUND

Such sealing elements are used to absorb liquid, in particular water displaced to the side when driving in the rain or blowing snow or displaced cleaning liquid when cleaning the windshield in the channel section and divert it along the front edge of the vehicle door or the front side window.

It has been shown that situations regularly occur in which the water received in the channel section is not discharged, but is forced out of the channel section due to the air currents and is conveyed backward along the side window. This results in a deteriorated or restricted view through the side window. It has been shown in particular that the view of the side mirror in question is impaired by the water-wetted side window.

### SUMMARY OF INVENTION

The object on which the invention is based is seen in specifying a sealing element in which the above disadvantages can be avoided.

This object is achieved by a sealing element with the features of claim 1, by a front vehicle door with the features of claim 5, by a motor vehicle with the features of claim 6, and by a method with the features of claim 8. Advantageous configurations with expedient further developments are specified in the dependent claims.

What is proposed is a sealing element for a front vehicle door having at least one fastening section by means of which the sealing element can be fastened to a frame element of the vehicle door, and having at least one channel section which, in the mounted state on the vehicle door, is designed to form a drainage channel between the frame element of the vehicle door and a side wall support of the vehicle frame. According to an embodiment the invention, the sealing element has a cover section which partially covers the channel section toward the outside, and in particular covers at least half the clear width of the channel section. The cover section can prevent water discharged in the channel section from escaping to the side window. The cover section forms a kind of cover for the channel section, so that the air current can exert less or hardly any effects on the water running off in the channel section.

The cover section can be provided on part of a total length of the sealing element, in particular about 5% to 50% of the total length, preferably about 10% to 30% of the total length. This ensures that displaced water can be reliably introduced into the channel section and cannot escape from the channel section in the region that is relevant for the restricted view through the side window due to the cover section arranged there.

The cover section can be connected to the fastening section on one side and have a free end in the region of the channel section. In this case, the channel section can have a sealing lip which, in the mounted state of the sealing element, abuts against the vehicle door and, when the vehicle door is closed, is in contact with the side wall frame, the cover section being dimensioned such that the sealing lip is received between the free end of the cover section and the side wall frame. As a result, the cover section and the sealing lip of the channel section form a tubular structure from which the water running off in the channel section can only exit with difficulty or not at all.

The above object is also achieved by a front vehicle door having a sealing element described above or by a motor vehicle having at least one such front vehicle door.

In the motor vehicle, the sealing element can extend from a front lower region along an upper edge of a window opening to a rear door frame section in the vehicle door, the cover section beginning at the front lower region and ending at an end height in relation to the clear height of the window opening, which corresponds to about 30% to 80% of the clear height, in particular about 40% to 60%.

The cover section is therefore provided in particular along a lower half of the side window, so that this region of the side window remains substantially free of laterally displaced water and the view of the side mirror is improved.

A method for producing a sealing element described above comprises the steps of:

extruding a strand of the sealing element with the cover section;

cutting the strand to a sealing element length suitable for a relevant front vehicle door; and

partially removing the cover section.

With this method, the sealing element including the cover section can be produced in a simple manner as an extruded profile. The cover section can then be subsequently removed where it is necessary for a relevant front vehicle door. It is therefore also conceivable that the extruded sealing element including the cover section is used in a plurality of different vehicle types, more or less of the cover section being removed depending on the door and side window geometry.

### BRIEF DESCRIPTION OF THE FIGURES

Further advantages, features and details of the invention will become apparent from the claims, the following description of preferred embodiments and from the drawings. In the drawings:

FIG. 1 is a simplified and schematic view of a vehicle door with a sealing element.

FIG. 2 is a perspective partial sectional view through a frame element of the vehicle door and the sealing element.

FIG. 3 is a schematic and simplified sectional view of the sealing element attached to the frame element.

### DETAILED DESCRIPTION

FIG. 1 shows, in a simplified and schematic side view, a front vehicle door 10 of a motor vehicle that is otherwise not shown in detail. The vehicle door has a window opening 12. A sealing element 16 is arranged along a front and upper frame element 14 of the vehicle door. This sealing element 16 is connected to the movable frame element of the vehicle door 10. When the vehicle door is opened or closed in its mounted state on a vehicle, the sealing element 16 is moved or pivoted together with the frame element 14 or the vehicle door 10.

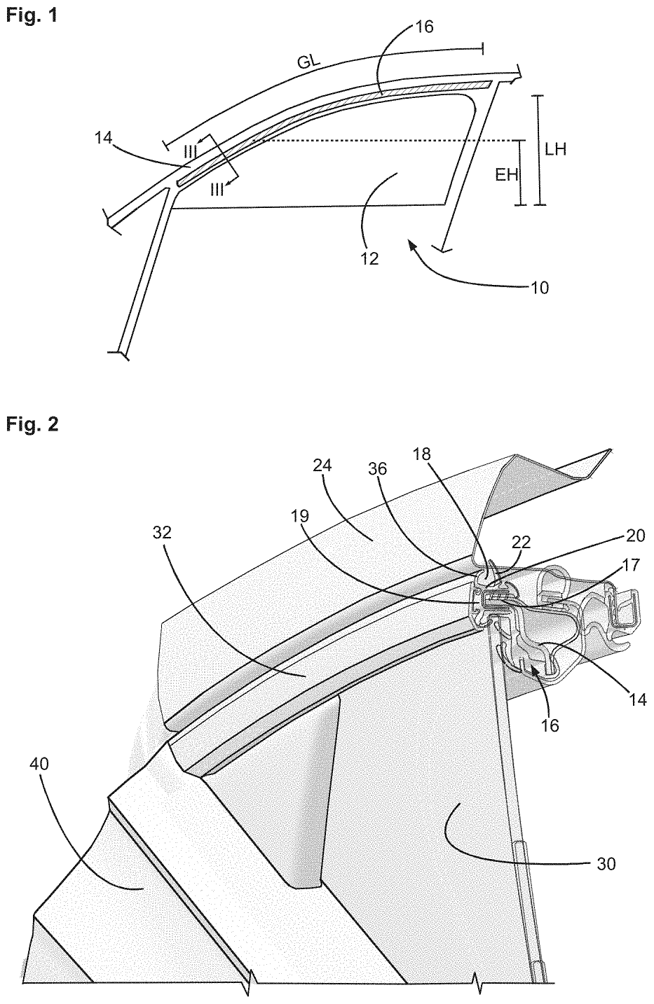

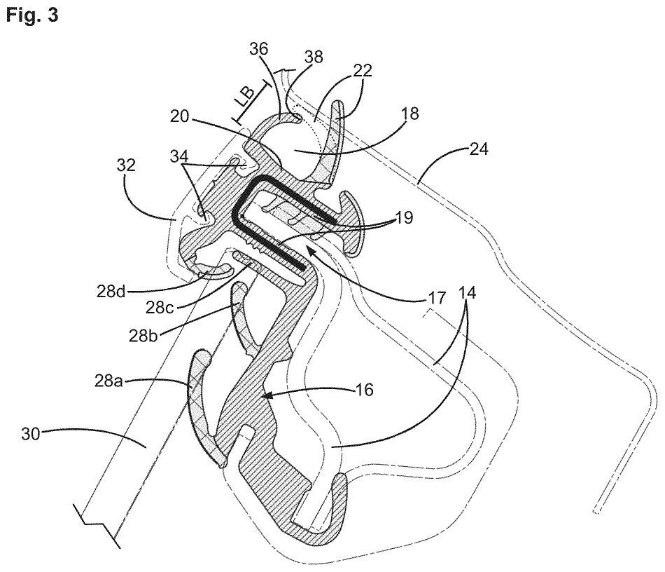

The sealing element 16 and its function will be described in more detail below with reference to the perspective partial sectional view of FIG. 2 and the cross-sectional view of FIG. 3. FIGS. 2 and 3 show a section which corresponds approximately to the section line in FIG. 1.

FIGS. 2 and 3 show the sealing element 16 schematically and in simplified form with relaxed sealing lip sections, i.e. the sealing lip sections are shown overlapping with those components on which they actually fit in a sealing manner.

As already explained, the sealing element 16 is arranged or fastened to a frame element 12 of the vehicle door 10 by means of a fastening section 19. The sealing element 16 has a channel section 18 in a front region, which is arranged in particular in front of a flange section 17 of the frame element 14. The channel section 18 serves to absorb water displaced by the windshield of the vehicle and to divert it downward along the frame element 14.

The channel section comprises a rear wall section 20 and a sealing lip 22 which are connected to one another. As can be seen from FIG. 3, the sealing lip 22 is movable between a relaxed position (solid lines, crossed hatching) and a tensioned position (shown in dashed lines). In the tensioned position (shown in dashed lines) the sealing lip 22 and thus the sealing element 16 adjoins a side wall support 24 of the motor vehicle.

In a rear region, in particular behind the flange section 17 of the frame element 14, the sealing element 16 comprises a window guide section 26. The window guide section 26 comprises a plurality of sealing lip sections 28a, 28b, 28c, 28d, which serve to guide the side window 30 within the window cutout 12 of the vehicle door 10 to produce a seal between the side window 30 and the frame element 14.

A panel element 32 or a decorative or glossy strip can be attached along an outer side of the sealing element 16, in particular by means of latching or clip connections 34.

The sealing element 16 comprises a cover section 36 in the region of the channel section 18. The cover section 36 partially covers the channel section 18 toward the outside. In particular, the cover section 36 covers at least half of the clear width LB of the channel section 18.

The sealing element 16 has a total length GL, which is shown in simplified form in FIG. 1. The total length can be understood to mean the curved extension of the sealing element 16 measured along the window opening. The cover section 36 shown in FIGS. 2 and 3 can be provided on part of a total length GL of the sealing element 16, in particular about 5% to 50% of the total length, preferably about 10% to 30% of the total length. In particular, the cover section can be arranged in a front region of the sealing element 16, which is designated by AS in FIG. 1. In relation to a clear height LH of the window opening 12, the cover section can end at an end height EH which corresponds to about 30% to 80% of the clear height LH, in particular about 40% to 60%, which is shown in purely qualitative terms in FIG. 1.

The cover section 36 is connected on one side to the fastening section 19 and has a free end 38 in the region of the channel section 18. In other words, the cover section 36 is connected in one piece to the wall section 20 of the channel section 18. In the mounted state on the vehicle and with the vehicle door closed, the sealing lip 22 is in contact with the side wall frame 24 (shown in dashed lines in FIG. 3). The cover section 36 is dimensioned or shaped and designed such that the sealing lip 20 is received between the free end 38 of the cover section 36 and the side wall frame 24. This forms an almost closed channel section 18 (FIG. 3: cover section 36 in cooperation with the sealing lip 22 shown in dashed lines), from which drained water cannot be entrained due to air currents and thus cannot escape from the channel section 18.

It can thus be prevented that water located in the channel section 18, which usually enters the channel section 18 of the sealing element 16 in an upper region, can be drained down to a door panel 40 without the drained water contaminating a lower region of the side window 30 and impairing the view, in particular the view of a side mirror. Furthermore, the cover section 36 also has a positive aerodynamic effect because it counteracts air turbulence that occurs when the channel section 18 is not covered.

A sealing element 16 can be produced, for example, according to a method. The method comprises a step in which a strand of the sealing element 16 with the cover section 36 is extruded. According to a step, the strand is cut to a sealing element length suitable for a relevant front vehicle door, in particular with the total length GL described above. In a step, the cover section 36 is partially removed, in particular such that the cover section 36 is only present in a front lower region of the sealing element 16, as has been described above with reference to the total length GL of the sealing element 16 or the clear height LH of the window opening 12.

1-8. (canceled)

9. A sealing element for a front vehicle door, comprising:
a fastening section configured to fasten to a frame element of the front vehicle door, such that the sealing element is set in a mounted state when the fastening section is fastened to the frame element of the front vehicle door;
a channel section configured to form a drainage channel between the frame element of the vehicle door and a side wall support of the vehicle frame when the sealing element is set in the mounted state, wherein the channel section defines a clearance along an exterior side of the channel section, the clearance opening into the drainage channel;
a cover section covering at least half a width of the clearance of the channel section.

10. The sealing element according to claim 9, wherein the cover section is disposed along a segment of the sealing element, and the segment of the sealing element is about 5% to about 50% of a total length of the sealing element.

11. The sealing element according to claim 9, wherein the cover section is connected to a side of the fastening section, and the cover section includes a free end disposed in the clearance of the channel section.

12. The sealing element according to claim 11, wherein the channel section includes a sealing lip configured to move between a relaxed position and a tensioned position,
wherein set in the relaxed position, the sealing lip is spatially separated from the free end of the cover section, and
wherein set in the tensioned position, the sealing lip is engaged between the free end of the cover section and the side wall frame of the vehicle.

13. A front vehicle door for a vehicle having a side wall support, comprising:
a frame element;
a sealing element, wherein the sealing element comprises:
a fastening section configured to fasten to the frame element of the front vehicle door, such that the sealing element is set in a mounted state when the fastening section is fastened to the frame element of the front vehicle door;
a channel section configured to form a drainage channel between the frame element of the vehicle door and a side wall support of the vehicle frame when the sealing element is set in the mounted state, wherein the channel section defines a clearance along an exterior side of the channel section, the clearance opening into the drainage channel; and
a cover section covering at least half a width of the clearance of the channel section.

14. A motor vehicle comprising:
a front vehicle door having a frame element;
a sidewall support for receiving the front vehicle door; and
a sealing element, wherein the sealing element comprises
a fastening section configured to fasten to the frame element of the front vehicle door, such that the sealing element is set in a mounted state when the fastening section is fastened to the frame element of the front vehicle door;
a channel section configured to form a drainage channel between the frame element of the vehicle door and a side wall support of the vehicle frame when the sealing element is set in the mounted state, wherein the channel section defines a clearance along an exterior side of the channel section, the clearance opening into the drainage channel; and
a cover section covering at least half a width of the clearance of the channel section.

15. The motor vehicle according to claim 14, wherein the sealing element extends from a first end at a front lower region along an upper edge of a window opening to a second end at a rear door frame section in the vehicle door, and the sealing element includes a clear height defined in a vertical direction between the first end of the sealing element and the second end of the sealing element,
wherein the cover section extends from a first end at the front lower region to a second end disposed along the sealing element, the cover section includes an end height defined in a vertical direction between the first end of the cover section and the second end of the cover section, and the end height corresponds to about 30% to 80% of the clear height of the sealing element.

16. A method of manufacturing a sealing element, comprising:
extruding a strand of the sealing element with a cover section;
cutting the strand to a sealing element length that corresponds to a length of a front vehicle door; and
removing the cover section from a part of the sealing element.
